(19) United States
(12) Patent Application Publication
(10) Pub. No.: US 2007/0265019 A1
(43) Pub. Date: Nov. 15, 2007

(54) METHOD AND APPARATUS FOR SWITCHING THE MODE OF RADIO EQUIPMENT IN CERTAIN ENVIRONMENTS

(76) Inventor: Xavier Rey-Robert, La Gaude (FR)

Correspondence Address: HOFFMAN, WARNICK & D'ALESSANDRO LLC, 75 STATE ST, 14 FL, ALBANY, NY, 12207, US

(21) Appl. No.: 11/746,839

(22) Filed: May 10, 2007

(30) Foreign Application Priority Data
May 11, 2006 (EP) 06300454.3

(51) Int. Cl. H04Q 7/20

(52) U.S. Cl. 455/456.4

(57) ABSTRACT

The present invention is directed to a method and apparatus for switching the mode of radio equipment in certain environments. In accordance with an embodiment, there is provided a method for causing a device operating in a first mode and located in a particular vicinity to operate in a predetermined second mode, including: broadcasting a request to a device located in the particular vicinity; and adjusting at least one setting of the device in response to the request, such that if the device operates in the particular vicinity it will operate in the predetermined second mode.

### FIELD OF THE INVENTION

The present invention relates generally to a method and apparatus for switching the mode of radio equipment in certain environments. More particularly, the present invention relates to a method and apparatus for switching the mode of mobile phones in environments where their ringing could cause problems.

### BACKGROUND OF THE INVENTION

Mobile phones users are everywhere, in the cinema, in hospitals, on airplanes, at meetings, etc. A telephone in such environments may interrupt the enjoyment of a film, disturb equipment, or generally cause a nuisance to people as the case may be. In particular, in hospitals and on airplanes, the use and activation of a mobile telephone can cause problems to the equipment in those areas and may be dangerous. It is very easy for people to forget to switch off their telephone in these environments or others. This can create a nuisance for people in the vicinity and can cause embarrassment for the owner of the telephone.

Certain cinemas and hospitals and other environments have attempted to solve the problem by installing radio jammers to disrupt telephone reception and therefore prevent telephones from ringing. The problem with such devices is that they are illegal in some countries and can disturb sensitive equipment in environments such as hospitals or airplanes.

Accordingly, there exists a need for a way to ensure that when mobile telephone users forget to switch off their telephone in certain environments where use of the telephone would be a nuisance or a danger, that something is done.

### SUMMARY OF THE INVENTION

The present invention is directed to a method and apparatus for switching the mode of radio equipment in certain environments.

In accordance with an aspect of the present invention, there is provided a method for causing a device operating in a first mode and located in a particular vicinity to operate in a predetermined second mode, comprising: broadcasting a request to a device located in the particular vicinity; and adjusting at least one setting of the device in response to the request, such that if the device operates in the particular vicinity it will operate in the predetermined second mode.

In accordance with another aspect of the present invention, there is provided a method of operating a mobile communication device in a vicinity of a broadcasting apparatus, wherein the broadcasting apparatus generates a request in the vicinity for changing an operating mode of the mobile communications device from a first mode to a predetermined second mode, the method comprising: setting a request threshold for the mobile communication device; receiving the request from the broadcasting apparatus; and changing the operating mode of the mobile communication device from the first mode to the predetermined second mode if the request is above the request threshold.

In accordance with another aspect of the present invention, there is provided a system for causing a device operating in a first mode and located in a particular vicinity to operate in a predetermined second mode, comprising: a system for broadcasting a request to a device located in the particular vicinity; and a system for adjusting at least one setting of the device in response to the broadcasted request, such that if the device operates in the particular vicinity it will operate in the predetermined second mode.

In accordance with another aspect of the invention, there is provided a mobile communication system, wherein the mobile communications device operates in a vicinity of a broadcasting apparatus, and wherein the broadcasting apparatus generates a request in the vicinity for changing an operating mode of the mobile communications device from a first mode to a predetermined second mode, comprising: a system for setting a request threshold for the mobile communication device; a system for receiving the request from the broadcasting apparatus; and a system for changing the operating mode of the mobile communication device from the first mode to the predetermined second mode if the request is above the request threshold.

Using the present invention, devices that are willing to comply with a mode change or silence request may be made silent or switched off without any action being necessary by the user. This will reduce the number of frustrating interruptions to a film, meeting, or the like. In addition, users can set up their own devices to always comply with requests to silence/switch off or further define the conditions with which their device will comply.

### BRIEF DESCRIPTION OF THE DRAWINGS

These and other features of this invention will be more readily understood from the following detailed description of the various aspects of the invention taken in conjunction with the accompanying drawings.

FIG. 1 depicts the operation of an illustrative system in accordance with an embodiment of the present invention.

FIG. 2 depicts the operation of an illustrative system in accordance with another embodiment of the present invention.

FIG. 3 is a flowchart of an illustrative process carried out at the requester end, in accordance with an embodiment of the present invention.

FIG. 4 is a flowchart of an illustrative process carried out at the receiver end, in accordance with an embodiment of the present invention.

### DETAILED DESCRIPTION OF THE INVENTION

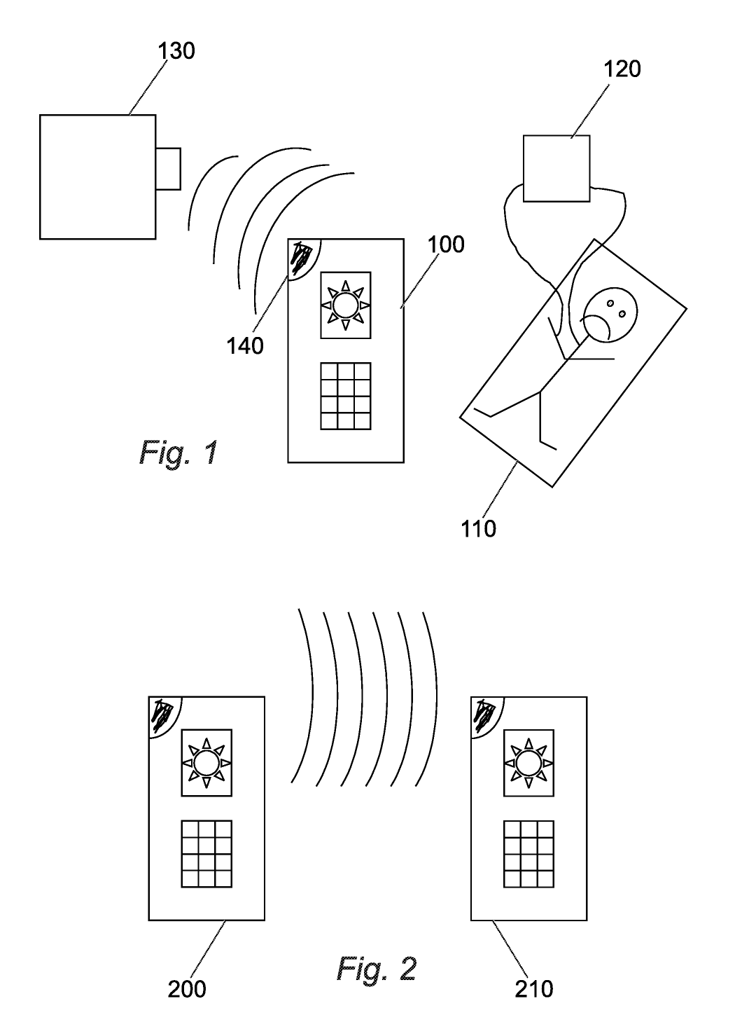

Referring to FIG. 1, a mobile telephone 100 is shown located in a hospital room in which a patient 110 is found on a bed. The patient 110 is attached to sensitive radio based equipment 120 for monitoring the vital signs of the patient 110. Also located in the hospital is a device 130, in accordance with the present invention, referred to as a requester or requesting apparatus. By the same token, the mobile telephone 100 is referred to as a receiver or a peer requester. Details of these terms will become clear later in the description.

A requester can be of two types as previously indicated. The requester can be a peer requester or a requesting apparatus. A peer requester is an end user device that is able to comply to “silence requests” or mode change requests and is also able to send “silence requests” or mode change requests. A requesting apparatus is merely designed for the purpose of sending “silence requests.” A silence request is a demand to switch the device to a silent operating mode. A silent operating mode is one which switches the device into a mode in which the device will not admit any noise, for example rings, sounds, music, etc.

It is possible in certain circumstances that the mode change effected by the requester (apparatus or peer) may be something different than a request for silent operation. Instead, the mode change of the device could be to turn off the device or set it to emergency reception and calling only or any other appropriate mode. It will be appreciated that this appropriate mode is any mode which is different in some way from the starting mode of the device.

Returning again to FIG. 1, the requester 130 broadcasts the silence request to all receivers in the vicinity. In this case, requester 130 broadcasts a mode change request (for silence or possibly to switch off) to all receivers, including mobile telephone 100, in its vicinity. The range over which the request is transmitted (the radio signal range) can be limited by the radio technology used. Examples of radio technology include Bluetooth, Wi-Fi, etc., shown generally at 140. In addition, shielding or the nature of the signal can include some details which describe and determine the range of coverage of a specific requester. There is generally no need for any determination of distance between the different elements within the system, it is merely the range of transmission of the requester that is specified. Although, in other environments, other information may be used, such as frequency, power levels, etc.

In certain environments, the requester 130 operates automatically, in that is set up to broadcast permanently, during specific hours or even during specific events, the required mode change request. These types of devices would typically be expected to be found in cinemas, hospitals, restaurants, airplane gates, etc. In the example of a hospital, the mode change request may be permanently set, so that at all times the mobile telephone 100 is in the hospital it will be requested to stay silent and not ring. Similarly, any other devices (e.g., laptop computers, PDAs, etc.) can be asked to operate in a silent mode. In addition, the hospital may transmit a signal which enables the device 100 to in fact be switched off rather than operate merely in a silent mode in areas of the hospital where mobile telephones, computers and other devices may interfere dangerously with the equipment.

At an airplane gate the mode request may be a switch off command or request which is set permanently set.

In the example of cinemas and restaurants, the transmission of a silent request may only occur during screenings or during specific meal times.

In the environment of a meeting, devices such as mobile telephones and laptops can also act as a requester for any other mobile telephones, laptops. etc., in the vicinity. In this case, the device acts like a requester, but in a peer to peer mode as opposed to the case of the requesting apparatus of the previous example.

Accordingly, referring to FIG. 2, the peer requester 200 may broadcast a silence request during a specific event, for example a meeting or a conference or a presentation using a transmitter, e.g., Bluetooth, infrared, etc., 140. On receipt of the silence request, all other mobile phones, laptops, etc., 210 may change themselves to silent operation if they are set up so to do.

All receivers can receive all silence requests that are broadcast either from a peer type requester or an apparatus type requester. The user of the receiver (mobile phones, laptops, etc.) can set up the device to comply or not with the silence requests. In addition, the user set up may include the ability of the receiver to distinguish between requests from different kinds of requesters (e.g., peer requesters or apparatus requesters, or from different environments (hospital/cinema, etc.)) or the ability to determine the level of the requester. That is to say that the transmissions made by peer requesters or apparatus requesters can have different levels. The levels may be set up in the original set up process for the requester and be an indicator of how important it is for the device to comply therewith. For example, a requester in a hospital may be at a higher level than a requester in a cinema or restaurant.

The user may decide to set their receiving device to comply with all requesters making a mode change request above a certain level at all times. For lower level requests for mode change the user may decide to set their device to comply only at certain times or for certain telephone numbers. For example, the compliance level may be set such that for mode change request from peer requesters may only occur outside office hours. The mode change requests could also be associated with a requirement for allowing certain telephone calls to be received and certain telephone calls not to be received irrespective of the compliance levels and the requester levels. For example, a telephone number of incoming calls may be excluded from compliance at specific compliance levels. For example a call from a certain number can be received at level request but not at a second level request.

The requesters may be set to operate at more than two levels. For example, a telephone or laptop that is the receiver may set the requester level to be implemented automatically at levels “1” and “2” for the requester, but be selective for levels “3” and “4,” for example. This may be preset in the telephone in an appropriate menu for doing so.

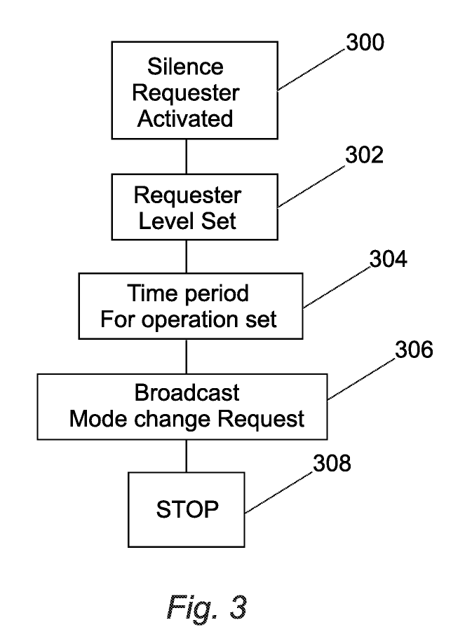

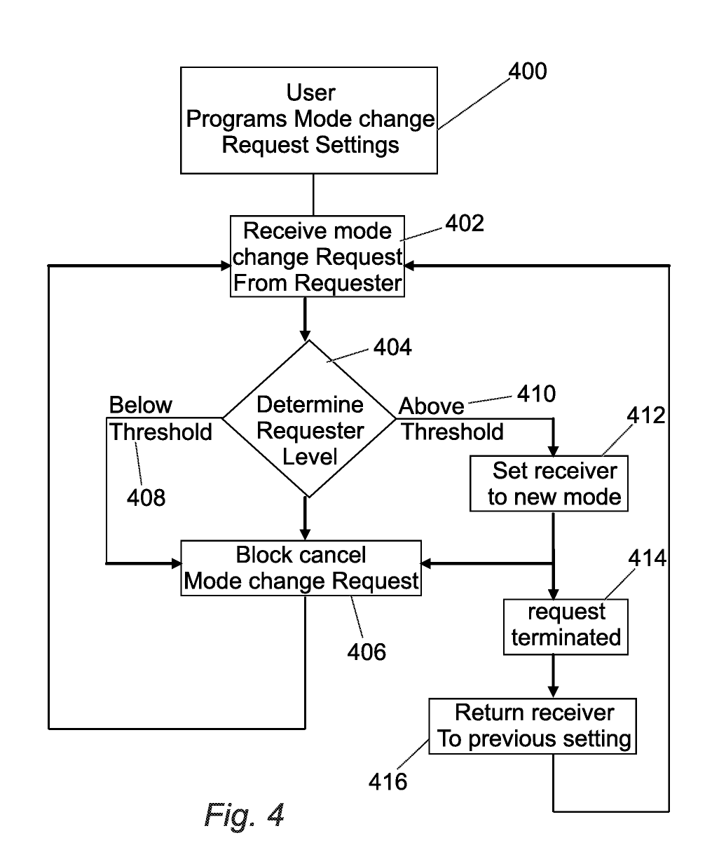

The flow diagrams in FIGS. 3 and 4 show the details of how the requester sends out a mode change request and how the receiver receives and processes such a request. Any broadcast from the requester may be picked up by the receiver using wireless means such as Bluetooth or any other appropriate medium. Alternatively, infrared or other electromagnetic frequencies may be used to communicate the broadcast mode change or silence request to the receiver.

Referring now to FIG. 3, the silence requester is activated (300). The requested level is then set (302). At the same time, the frequency of the requester may be activated and set as may any other features of the requester that are necessary to be set, for example the mode change that is required from the device. The required time period for which the requester is to operate is then determined and set (304). The time period can be permanent for those devices at a certain requester level which we required to operate all the time, for example in a hospital, on an airplane, or anywhere else where the devices may cause danger. The requester then broadcasts (306) the request has as set up in 302 and 304. The request continues until such time is the time period for operation is finished at which time the requester stops (308).

Turning now to the receiver end now illustrated in FIG. 4, the user of the receiver programs the request settings within the device (400). At any time in the future, the receiver may receive (402) a silence or mode change request, from a requester. The receiver must then determine (404) what level the requester level is set at. In certain circumstances, the user may have the ability to immediately block or cancel (406) any request. In this case, the process loops back to the position where it might again receive a silence or mode change request from the requester and the process starts again.

If the requester level of the requester is below a certain threshold (408) as determined by the receiver at 404, the receiver will block or cancel any silence request and return the device to be ready for the next request that might come along in the same way as previously indicated. However, if the request level from the request device is above the threshold (410) set by the receive device, the receive device will set (412) the receiver to a silent or other new mode.

At some stage during the time that the receiver is set at a silent mode, the user may chose to block or cancel the silence request as previously indicated at 406. Again, if this is the case, the device resorts to awaiting the next request for silence request. If the user does not block or cancel the request, the request will continue until terminated (414). This termination may be bought about by the requesting apparatus stopping or by the user leaving the vicinity of the requester.

As soon as the silence or mode change request is terminated, the device returns to its previous setting or original mode of operation, unless the device has been switched off, in which case the user must reactive the device (416).

The mobile phone or laptop referred to herein may be referred to as a mobile communications device. This definition is not limited to just these mobile communications devices but may include others as will be clear to person skilled in the art.

In order to implement an example of the method, the telephone or other device may include an additional (e.g., silent request) menu in the standard menu list. The user can select this menu and make the required changes to the setting of the device. At the other end of the system, the requester may be included in a base station or equivalent for sending the silence request. The setup of the requester to be able to send requests and at which level the request can be made may be made by programming a transmitter associated with the base station or equivalent means. The request may be modulated or otherwise processed to be carried on any type of transmission generated by the transmitter. If the transmitter forms part of a base station, there only needs to be modification to the base station in terms of enabling the silence or other mode change request to be transmitted via the transmitter either alone or integrated with other transmissions. If the transmitter is not associated with a base station, the transmitter will operate in any necessary manner to transmit the request signal.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal travelling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

While the invention has been particularly shown and described with reference to a preferred embodiment, it will be understood that various changes in form and detail may be made therein without departing from the spirit, and scope of the invention.

1. A method for causing a device operating in a first mode and located in a particular vicinity to operate in a predetermined second mode, comprising:
broadcasting a request to a device located in the particular vicinity; and
adjusting at least one setting of the device in response to the broadcasted request, such that if the device operates in the particular vicinity it will operate in the predetermined second mode.

2. The method of claim 1, further comprising:
setting the broadcasted request to one of a plurality of levels depending on a nature of the vicinity, such that the device operates in the predetermined mode in response to a first of the plurality of levels and the device operates in another mode in response to another of the plurality of levels.

3. The method of claim 1, further comprising:
setting the broadcasted request to last for a specific duration.

4. The method of claim 1, further comprising:
setting the broadcasted request to extend over a specific area.

5. The method of claim 1, further comprising:
stopping the broadcasted request to allow the device to return to the first mode.

6. The method of claim 1, further comprising:
selecting the request so as to enable the predetermined second mode to be selected from the group consisting of: a silent mode, a switched off mode, an emergency call mode, a selected number mode, and a compliance mode.

7. A computer program, stored on a recordable medium, comprising instructions for carrying out the steps of the method according to claim 1, when the computer program is executed on a computer system.

8. A method of operating a mobile communication device in a vicinity of a broadcasting apparatus, wherein the broadcasting apparatus generates a request in the vicinity for changing an operating mode of the mobile communications device from a first mode to a predetermined second mode, the method comprising:
setting a request threshold for the mobile communication device;
receiving the request from the broadcasting apparatus; and
changing the operating mode of the mobile communication device from the first mode to the predetermined second mode if the request is above the request threshold.

9. The method of claim 8, further comprising:
leaving the mobile communications device in the first mode if the request is below the threshold.

10. The method of claim 8, further comprising:
allowing the mobile communications device to return to the first mode if the mobile communication device leaves the vicinity.

11. The method of claim 8, further comprising:
allowing the mobile communications device to return to the first mode if the request is terminated.

12. A computer program, stored on a recordable medium, comprising instructions for carrying out the steps of the method according to claim 8, when the computer program is executed on a computer system.

13. A system for causing a device operating in a first mode and located in a particular vicinity to operate in a predetermined second mode, comprising:
a system for broadcasting a request to a device located in the particular vicinity; and
a system for adjusting at least one setting of the device in response to the broadcasted request, such that if the device operates in the particular vicinity it will operate in the predetermined second mode.

14. The system of claim 13, further comprising:
a system for setting the broadcasted request to one of a plurality of levels depending on a nature of the vicinity, such that the device operates in the predetermined mode in response to a first of the plurality of levels and the device operates in another mode in response to another of the plurality of levels.

15. The system of claim 13, further comprising:
a system for setting the broadcasted request to last for a specific duration.

16. The system of claim 13, further comprising:
a system for setting the broadcasted request to extend over a specific area.

17. The system of claim 13, further comprising:
a system for stopping the broadcasted request to allow the device to return to the first mode.

18. The system of claim 13, wherein the predetermined second mode is selected from the group consisting of: a silent mode, a switched off mode, an emergency call mode, a selected number mode, and a compliance mode.

19. A mobile communication system, wherein the mobile communications device operates in a vicinity of a broadcasting apparatus, and wherein the broadcasting apparatus generates a request in the vicinity for changing an operating mode of the mobile communications device from a first mode to a predetermined second mode, comprising:
a system for setting a request threshold for the mobile communication device;
a system for receiving the request from the broadcasting apparatus; and
a system for changing the operating mode of the mobile communication device from the first mode to the predetermined second mode if the request is above the request threshold.

20. The system of claim 19, further comprising:
a system for leaving the mobile communications device in the first mode if the request is below the threshold.

21. The system of claim 19, further comprising:
a system for allowing the mobile communications device to return to the first mode if the mobile communication device leaves the vicinity.

22. The system of claim 19, further comprising:
a system for allowing the mobile communications device to return to the first mode if the request is terminated.
